(19) United States
(12) Patent Application Publication
(10) Pub. No.: US 2018/0174013 A1
(43) Pub. Date: Jun. 21, 2018

(54) SMART CARD INCLUDING FINGERPRINT DETECTION DEVICE AND DRIVING METHOD THEREOF

(71) Applicant: CRUCIALTEC CO., LTD., Seongnam-si (KR)

(72) Inventor: Kwang Han LEE, Anseong-si (KR)

(21) Appl. No.: 15/576,721

(22) PCT Filed: May 26, 2016
(86) PCT No.: PCT/KR2016/005575

§ 371 Date: Nov. 23, 2017

(30) Foreign Application Priority Data
May 26, 2015 (KR) 10-2015-0073000
May 25, 2016 (KR) 10-2016-0064133

(51) Int. Cl. G06K 19/073; G06K 9/00; G06K 19/07

(52) U.S. Cl. CPC G06K 19/07354; G06K 19/0723; G06K 9/00087

(57) ABSTRACT

A smart card including a fingerprint detection device, the smart card including: a central processing unit; a microcontroller unit selectively connected to the central processing unit to perform fingerprint authentication on the basis of a fingerprint sensing signal received from the fingerprint detection device; and an auxiliary chip connected to the central processing unit to be activated if a result of the fingerprint authentication is successful.

### CROSS-REFERENCE TO RELATED APPLICATIONS

This application is a National Stage Entry of International Patent Application No. PCT/KR2016/005575, filed on May 26, 2016, and claims priority from and the benefit of Korean Patent Application No. 10-2015-0073000, filed on May 26, 2015, and Korean Patent Application No. 10-2016-0064133, filed on May 25, 2016, each of which are incorporated by reference for all purposes as if fully set forth herein.

### BACKGROUND

### Field

The present invention relates to a smart card including a fingerprint detection device, and an operating method of the same, and more particularly, to a smart card which is consumes low power and protects a fingerprint sensor from an external physical impact, and an operating method of the same.

### Discussion of the Background

Since people have different fingerprints, fingerprints are frequently used in the personal identification field. In particular, fingerprints are widely used as a means of personal authentication in various fields, such as finance, criminal investigation, security, and the like.

A fingerprint recognition sensor has been developed to recognize such a fingerprint and identify a person. The fingerprint recognition sensor is a device which comes into contact with a person's finger and recognizes the fingerprint, and is used as a means for determining whether the person is an acceptable user. According to fingerprint sensing principles, fingerprint sensors are classified into an optical sensor, a capacitive sensor, an ultrasonic sensor, a thermal sensor, and the like. Each type of fingerprint sensor obtains fingerprint image data from a finger according to an operating principle thereof.

Meanwhile, with the increase in the use of such a fingerprint sensor, a technology for including a fingerprint sensor in a smart card which includes an integrated circuit (IC) chip has been developed for security of the smart card. When a fingerprint sensor is embedded in a smart card, it is possible to determine whether the smart card is used by an acceptable user on the basis of a fingerprint, which is unique information of a user, such that security of using the smart card may be improved.

When a fingerprint sensor is applied to a smart card, power is required to operate the fingerprint sensor. Generally, a battery applied to a smart card has a small capacity, and thus it is necessary to make efforts to minimize power consumption of a fingerprint sensor and components which process a fingerprint detection signal.

Currently, a method of lowering current consumption by improving switch operation and a microcontroller unit (MCU) included in a smart card has been suggested. However, since the microcontroller consumes a large current, current consumption is not effectively reduced even in a sleep mode when the smart card continuously operates.

### SUMMARY

The present invention is directed to solving the above-described problems of a conventional art and minimizing current consumption during processes of fingerprint recognition, fingerprint authentication, a unique operation, and the like in a smart card.

The present invention is also directed to omitting a physical button for supplying power to a smart card and minimizing current consumption of the smart card.

The present invention is also directed to providing a structure for protecting a fingerprint sensor from a physical impact applied to a smart card.

One aspect of the present invention provides a smart card including a fingerprint detection device, the smart card including: a central processing unit (CPU); a microcontroller unit (MCU) configured to be selectively connected to the CPU and perform fingerprint authentication based on a fingerprint sensing signal received from the fingerprint detection device; and an auxiliary chip configured to be connected to the CPU and activated when a result of the fingerprint authentication is success.

The MCU may be operated in a sleep mode when connected to the CPU and may be switched to an active mode and perform the fingerprint authentication when a magnitude of an electrical signal received from the fingerprint detection device exceeds a reference value.

When the auxiliary chip is activated, the MCU may be disconnected from the CPU.

The smart card may further include: a first switch configured to connect the CPU, the MCU, and the fingerprint detection device when power is supplied to the CPU; and a second switch configured to connect the auxiliary chip and the CPU when the result of the fingerprint authentication is success.

The smart card may further include a physical switch configured to supply the power to the CPU.

The smart card may further include a display device configured to be controlled by the CPU and display the fingerprint authentication result information and operation result information of the auxiliary chip and the CPU.

The fingerprint detection device may include a fingerprint sensor and an external electrode formed to surround the fingerprint sensor, and when an electrical signal received from the external electrode of the fingerprint detection device exceeds a reference value, the CPU may activate the MCU and the fingerprint authentication operation may be performed.

The smart card may further include a switch configured to connect the CPU and the MCU when the electrical signal exceeds the reference value.

The fingerprint detection device may include a fingerprint sensor; and a support unit configured to be formed in a ring shape surrounding the fingerprint sensor and made of a metallic material.

An upper surface of the support unit may be formed to have a height equal to or higher than a height of an upper surface of the fingerprint sensor.

An upper surface of the support unit may be formed to be higher than an upper surface of the fingerprint sensor and bent inward toward the fingerprint sensor to cover edges of the upper surface of the fingerprint sensor.

The support unit may be formed to have a structure having flat upper and lower surfaces, a structure whose upper surface has rounded edges, or a structure whose upper portion has an inner diameter gradually increased near the upper surface.

A flange may be formed around a lower portion of the support unit.

Another aspect of the present invention provides a smart card including: a fingerprint detection device configured to include a fingerprint sensor and an external electrode formed to surround the fingerprint sensor; and an MCU configured to be operated in a sleep mode when power is applied thereto and switched to an active mode in which a fingerprint authentication process is performed when an electrical signal received from the external electrode exceeds a reference value.

The smart card may further include a switch configured to connect the fingerprint sensor and the MCU when the electrical signal received from the external electrode exceeds the reference value.

Another aspect of the present invention provides an operating method of a smart card including a fingerprint detection device, the method including: receiving, by a CPU, power and operating an MCU in a sleep mode; receiving, by the MCU, an electrical signal from the fingerprint detection device and comparing the electrical signal with a reference value; when the electrical signal exceeds the reference value, switching the MCU to an active mode, and performing, by the MCU, a fingerprint authentication process; and when a result of the fingerprint authentication is successful, activating, by the CPU, an auxiliary chip.

The operating method may further include disconnecting, by the CPU, the MCU from the CPU when the result of fingerprint authentication is success.

Another aspect of the present invention provides an operating method of a smart card including a fingerprint detection device, the method including: receiving, by a CPU, an electrical signal from an external electrode of the fingerprint detection device and comparing the electrical signal with a reference value; and when the electrical signal exceeds the reference value, activating, by the CPU, an MCU so that a fingerprint authentication process is performed.

Another aspect of the present invention provides an operating method of a smart card including a fingerprint detection device, the method including: operating an MCU in a sleep mode, and receiving, by the MCU, an electrical signal from an external electrode of the fingerprint detection device; and when the electrical signal exceeds the reference value, connecting the MCU to a fingerprint sensor of the fingerprint detection device, and performing, by the MCU, a fingerprint authentication process.

According to the present invention, since a central processing unit (CPU), which controls a display device of a smart card and is operated at low current, controls overall operation of a microcontroller unit (MCU) which performs fingerprint authentication and the like, current consumption may be reduced during operation.

According to the present invention, since the MCU is activated and performs a fingerprint authentication operation only when a finger is present on a fingerprint detection device, current consumption can be further reduced.

According to the present invention, after the fingerprint authentication operation is completed by the MCU, a supply of power to the MCU is cut off, and thus current consumption can be minimized.

According to the present invention, since the CPU of the smart card activates the MCU, which performs the fingerprint authentication operation, only when a finger is present on the fingerprint detection device, it is possible to implement a smart card which consumes a small current without a physical switch for activating the CPU and the MCU.

According to the present invention, a ring-shaped support unit is provided around a fingerprint sensor, and thus the fingerprint sensor can be protected from a physical impact.

### BRIEF DESCRIPTION OF THE DRAWINGS

FIGS. 1A to 1C are plan views showing a structure of a smart card according to various embodiments of the present invention.

FIG. 2 is a rear view of a smart card according to an embodiment of the present invention.

FIG. 3 is a diagram showing a dispositional relationship between an auxiliary chip and a fingerprint detection device in a smart card according to an embodiment of the present invention.

FIG. 4 is a circuit diagram showing an internal configuration of a smart card according to an embodiment of the present invention.

FIG. 5 is a flowchart illustrating an operating method of the smart card shown in FIG. 4.

FIG. 6 is a circuit diagram showing an internal configuration of a smart card according to another embodiment of the present invention.

FIG. 7 is a circuit diagram showing an internal configuration of a smart card according to still another embodiment of the present invention.

FIG. 8 is an exploded perspective view showing a region in which a fingerprint detection device is formed on a front side of a smart card according to an embodiment of the present invention.

FIG. 9 is a cross-sectional view taken along line A-A′ of FIG. 8.

FIGS. 10 and 11 are diagrams showing configurations of a fingerprint detection device of a smart card according to other embodiments of the present invention.

FIGS. 12 to 14 are diagrams showing shapes of a support unit according to various embodiments of the present invention.

FIG. 15 is a perspective view showing a shape of a support unit according to another embodiment of the present invention.

FIG. 16 is a cross-sectional view showing a configuration of a fingerprint detection device of a smart card to which the support unit shown in FIG. 15 is applied.

### DETAILED DESCRIPTION

Hereinafter, the present invention will be described with reference to the accompanying drawings. However, the present invention may be implemented in various different forms, and thus is not limited to the embodiments described herein. In the drawings, parts unrelated to the description have been omitted to clearly describe the present invention, and like reference numerals indicate like elements throughout the specification.

In the specification, when a part is “connected” to another part, the parts may not only be “directly connected” to each other but may also be “indirectly connected” via an intermediate member. Also, when a part “includes” a certain component, another part may be included therein and is not excluded unless particularly defined otherwise.

Embodiments of the present invention will be described in detail below with reference to the accompanying drawings.

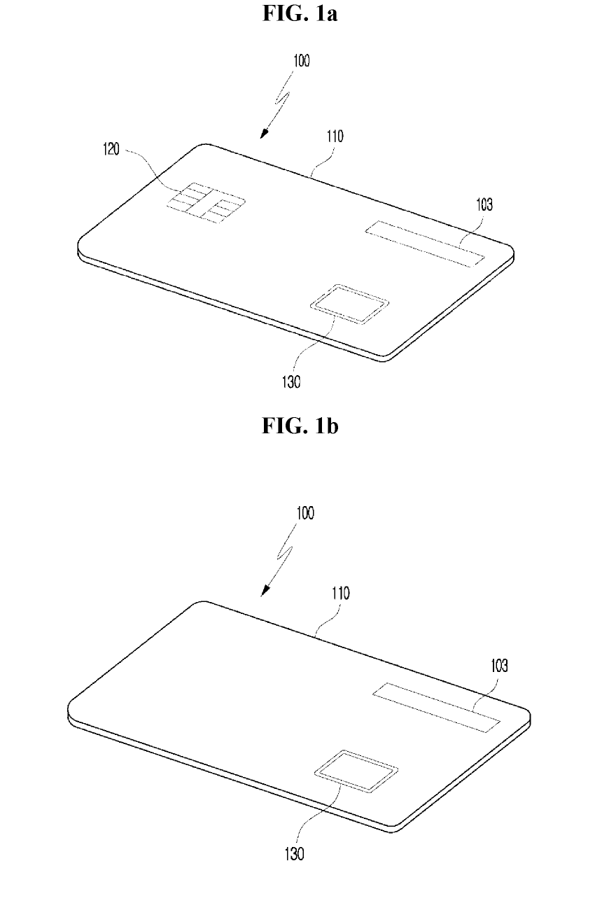

FIGS. 1A to 1C are plan views showing a structure of a smart card according to various embodiments of the present invention.

Referring to FIG. 1A, a smart card according to an embodiment includes a plate 110 made of a material such as plastic and the like, an auxiliary chip 120 disposed in a partial region of the plate 110, and a fingerprint detection device 130. When the smart card 100 is a one-time password (OTP) card or the like, a display device 103 may be further included in a partial region of the smart card 100. The display device 103 may be implemented as a liquid crystal display (LCD) device or an electrophoresis display (EPD), but is not limited thereto. For example, a light-emitting diode (LED) indicator may replace the display device 103. When the smart card 100 is an OTP card, the display device 103 may display a generated OTP number. The display device 103 may be omitted when the smart card 100 is not an OTP card or the like.

The auxiliary chip 120 is formed as a metal chip, and information on the smart card 100 (e.g., credit card information and the like) may be stored in an encrypted form in the auxiliary chip 120. As an example, the auxiliary chip 120 may be a EuroPay Mastercard Visa (EMV) chip conforming to the EMV standard. The auxiliary chip 120 may be implemented in the form of an integrated circuit (IC) chip, and may also be implemented in another chip form, such as a flash memory, a central processing unit (CPU), and the like.

The fingerprint detection device 130 functions to sense a fingerprint of a finger which comes into contact with an upper portion thereof. According to fingerprint sensing methods, the fingerprint detection device 130 may be implemented as a capacitive sensor, an optical sensor, an ultrasonic sensor, and the like.

When the fingerprint detection device 130 is implemented as a capacitive fingerprint sensor, different capacitances are separately generated by a plurality of electrodes or a plurality of sensing cells present in the fingerprint detection device 130 according to contact with ridges or valleys of a finger. Therefore, when signals separately output from the plurality of electrodes or the plurality of sensing cells are aggregated, a fingerprint image is acquired.

When the fingerprint detection device 130 is implemented as an optical fingerprint sensor, a feature of reflected light varies depending on whether light emitted from a light source comes into contact with a ridge or a valley. Therefore, when features of light reflected at each position of a fingerprint are aggregated, a fingerprint image may be acquired.

When the fingerprint detection device 130 is implemented as an ultrasonic sensor, ultrasonic waves emitted from an ultrasonic transmitter come into contact with ridges of a finger, are transmitted through the finger, come into contact with the upper surface of the fingerprint detection device 130, and are reflected. When such features are aggregated, a fingerprint image is acquired.

A detailed structure of the fingerprint detection device 130 according to an embodiment of the present invention will be described in further detail below.

Meanwhile, the smart card 100 according to another embodiment of the present invention may be implemented without the auxiliary chip 120, as shown in FIG. 1B, and the smart card 100 according to another embodiment of the present invention may be implemented without the auxiliary chip 120 and a display device 103, as shown in FIG. 1C.

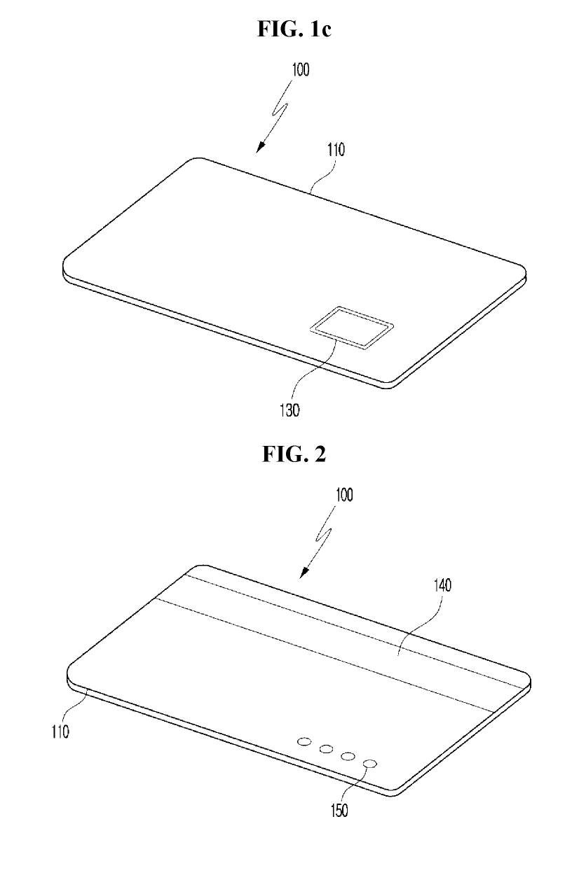

FIG. 2 is a rear view of a smart card according to an embodiment of the present invention.

Referring to FIG. 2, a magnetic strip 140 may be formed on a rear side of the plate 110 of the smart card 100. The magnetic strip 140 may include basic information (e.g., credit card information and the like) of the smart card 100. When the magnetic strip 140 is loaded into a card reader, the stored information may be transmitted to the card reader in a contact manner. To this end, the magnetic strip 140 may be formed at a position at which the magnetic strip 140 can be loaded into a card reader, preferably, close to an edge of the plate 110.

Meanwhile, a contact pad 150 for charging a battery embedded in the smart card 100 or transmitting and receiving data may be further provided in at least a part of the rear side of the plate 110.

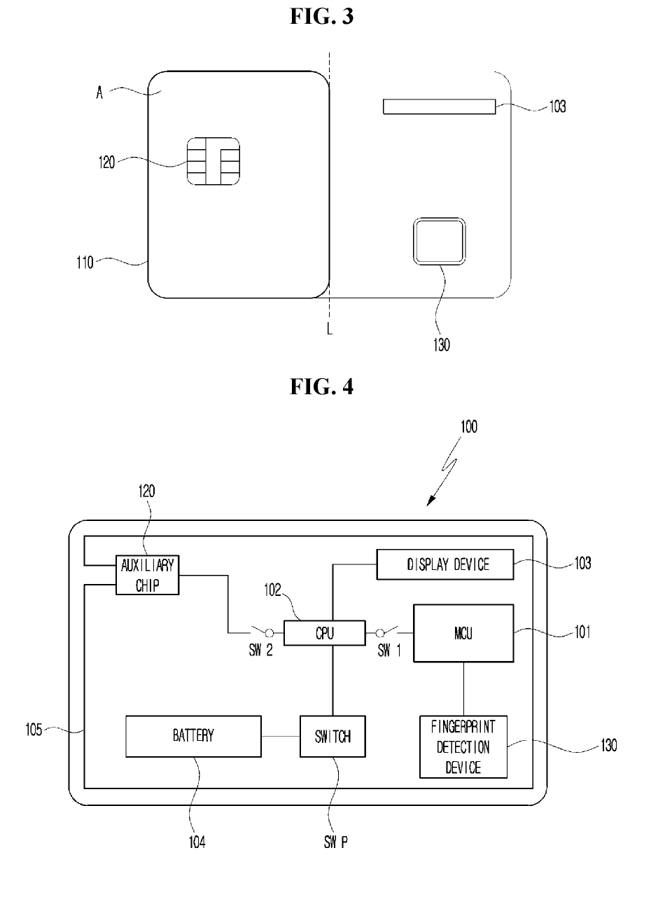

FIG. 3 is a diagram showing a dispositional relationship between the auxiliary chip 120 and the fingerprint detection device 130 in the smart card according to an embodiment of the present invention.

As described above, the auxiliary chip 120 and the fingerprint detection device 130 are formed on the front side of the plate 110 of the smart card 100. When the auxiliary chip 120 is implemented as an IC chip or the like, it is necessary to recognize the auxiliary chip 120 through a card reader, and, to this end, the auxiliary chip 120 should be loaded into an insertion hole of the card reader. Therefore, as shown in FIG. 3, it is necessary to insert a region A which covers the plate 110 from one edge of the plate 110 to the auxiliary chip 120 into the insertion hole of the card reader.

When the fingerprint detection device 130 is present in the region A and repeatedly inserted into an insertion hole of a card reader together with the auxiliary chip 120, the fingerprint detection device 130 may be damaged by physical friction against a guide device, such as a roller, which draws the smart card 100 into the card reader, and a function thereof may be lost in severe cases. To prevent such surface damage of the fingerprint detection device 130, it is preferable for the fingerprint detection device 130 to be formed in a region which is not inserted into a card reader together with the auxiliary chip 120 when the smart card 100 is inserted into the card reader. For example, when the plate 110 of the smart card 100 is divided into the region A including the auxiliary chip 120 and a region without the auxiliary chip 120 on the basis of a virtual straight line L including one edge of the auxiliary chip 120, the fingerprint detection device 130 may be formed in the region without the auxiliary chip 120. According to an exemplary embodiment, a distance between the virtual straight line L and one edge of the smart card 100 may be about 25 mm, and the fingerprint detection device 130 may be formed between the virtual straight line L and the edge of the smart card 100.

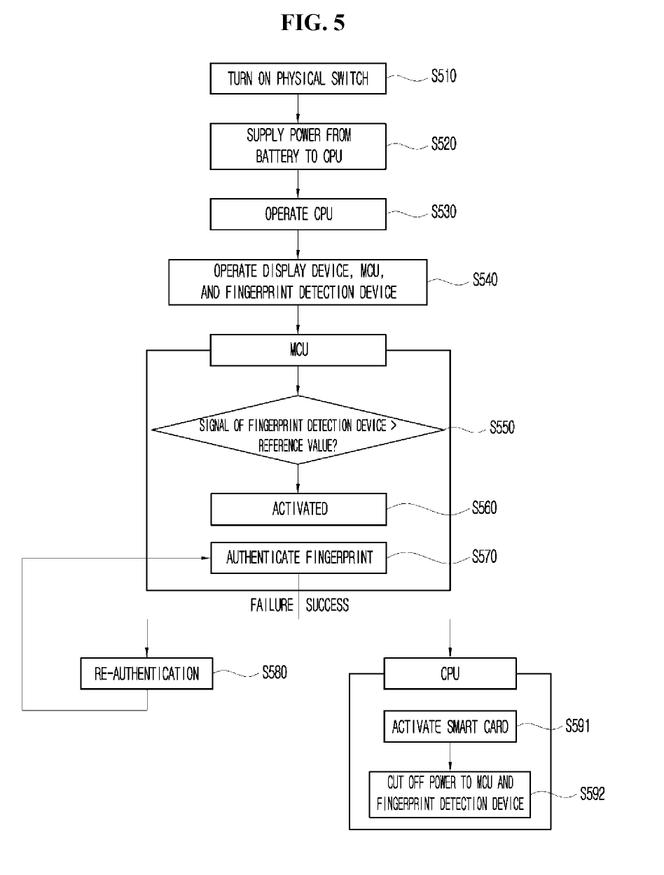

FIG. 4 is a circuit diagram showing an internal configuration of a smart card according to an embodiment of the present invention.

Referring to FIG. 4, the smart card 100 according to an embodiment may include the auxiliary chip 120, the fingerprint detection device 130, a microcontroller unit (MCU) 101, a CPU 102, the display device 103, and a battery 104.

Also, an antenna 105 which is disposed along an edge of the smart card 100 and handles a communication function between the auxiliary chip 120 and an external device may be further included.

Meanwhile, three switches SWp, SW1, and SW2 may be connected to the CPU 102. The physical switch SWp connects or disconnects the CPU 102 and the battery 104, the first switch SW1 connects or disconnects the CPU 102 and the MCU 101, and the second switch SW2 connects or disconnects the CPU 102 and the auxiliary chip 120. The physical switch SWp may be implemented as a physical switch which may be manipulated by a user, and operation of the first and second switches SW1 and SW2 may be controlled by the CPU 102.

The MCU 101 according to an embodiment is connected to the fingerprint detection device 130 and receives a fingerprint detection signal transmitted from the fingerprint detection device 130 to acquire a fingerprint image through a built-in algorithm. After the fingerprint image is acquired, the MCU 101 may perform fingerprint authentication through a comparison operation with a previously stored fingerprint image. When the physical and first switches SWp and SW1 are switched to an on-state, the MCU 101 according to an embodiment is operated in a sleep mode. In this case, when a finger comes into contact with the fingerprint detection device 130 and a signal exceeding a reference value is received from the fingerprint detection device 130, the MCU 101 is switched to an active mode and performs fingerprint recognition and fingerprint authentication operations.

The CPU 102 according to an embodiment is selectively connected to the battery through the physical switch SWp, selectively connected to the MCU 101 through the first switch SW1, and selectively connected to the auxiliary chip 120 through the second switch SW2.

The display device 103 according to an embodiment is connected to the CPU 102 and operated under control of the CPU 102.

Meanwhile, FIG. 4 shows an example in which the battery 104 is embedded in the smart card 100. However, the smart card 100 is not limited to receiving driving power from the battery 104, and driving power may be received from the outside through the antenna 105 and the like. Also, the battery 104 may be implemented as an energy harvesting power source and the like which collects energy and converts the collected energy into electrical energy, or the auxiliary chip 120 may receive power by coming into contact with an external device which provides energy

FIG. 5 is a flowchart illustrating an operating method of the smart card shown in FIG. 4.

An operating method of a smart card according to an embodiment of the present invention will be described below with reference to FIGS. 4 and 5.

First, when the physical switch SWp is switched to the on-state by a user (S510), power is applied to the CPU 102 from the battery 104 (S520), and the CPU 102 is operated (S530).

At this time, the CPU 102 activates the display device 103 and operates the MCU 101 in the sleep mode by switching the first switch SW1 to the on-state (S540). When the first switch SW1 is switched to the on-state, the fingerprint detection device 130 is also connected to the CPU 102 through the MCU 101. Meanwhile, power supplied from the battery 104 is also supplied to the fingerprint detection device 130 through the CPU 102 and the MCU 101. Accordingly, the CPU 102, the MCU 101, and the fingerprint detection device 130 are activated (S540).

When the MCU 101 is operated in the sleep mode, the MCU 101 receives an electrical signal from the fingerprint detection device 130 periodically or aperiodically. The electrical signal may be a signal related to a change in an electrical feature occurring when a finger comes into contact with the fingerprint detection device 130. In other words, an electrical signal generated when no finger is present on the fingerprint detection device 130 differs from an electrical signal generated when a finger comes into contact with the fingerprint detection device 130, and the MCU 101 may determine whether a finger is present on the fingerprint detection device 130 through the electrical signal received from the fingerprint detection device 130.

To this end, the MCU 101 may store a range of a signal transmitted from the fingerprint detection device 130 when no finger is present on the fingerprint detection device 130 as a reference value, and may perform a process of comparing a corresponding signal transmitted from the fingerprint detection device 130 with the reference value (S550).

When the signal transmitted from the fingerprint detection device 130 does not exceed the reference value, the MCU 101 continuously monitors a signal transmitted from the fingerprint detection device 130.

On the other hand, when the signal transmitted from the fingerprint detection device 130 exceeds the reference value, a finger is present on the fingerprint detection device 130, and thus the MCU 101 is switched to the active mode to process a fingerprint sensing signal transmitted from the fingerprint detection device 130 (S560).

In the active mode, the MCU 101 acquires a fingerprint image through the fingerprint sensing signal transmitted from the fingerprint detection device 130 and performs a fingerprint authentication process (S570). The fingerprint image acquisition and fingerprint authentication process may be performed by an algorithm built into the MCU 101.

When a result of the fingerprint authentication is failure, a fingerprint re-authentication process may be performed (S580). In other words, the MCU 101 may perform the fingerprint authentication process again, receive fingerprint sensing information again from the fingerprint detection device 130, or transmit the failure result of the fingerprint authentication to the CPU 102 to display failure information of the fingerprint authentication on the display device 103 under control of the CPU 102.

On the other hand, when a result of the fingerprint authentication is success, the successful result of the fingerprint authentication is transferred to the CPU 102, and success information of the fingerprint authentication may be displayed on the display device 103 under control of the CPU 102. Also, when the fingerprint authentication is successful, the CPU 102 switches the second switch SW2 to the on-state to activate the function of the auxiliary chip 120. In other words, it is possible to activate the function of the smart card (S591). When the smart card function is activated, power from the battery 104 is also supplied to the auxiliary chip 120 through the CPU 102, and the auxiliary chip 120 may communicate with an external device in a contact or contactless manner. In the case in which the smart card 100 is an OTP card, when the auxiliary chip 120 is activated, OTP information may be received from an external device or generated by the smart card. Such OTP information may be displayed on the display device 103 by the CPU 102.

Meanwhile, the CPU 102 switches the first switch SW1 to an off-state at the same time as or immediately after switching the second switch SW2 to the on-state to prevent the power of the battery 104 from being supplied to the MCU 101 and the fingerprint detection device 130 (S592).

Since an MCU performs a main control function in most conventional smart cards, a function of a smart card is available only when the MCU is activated. However, according to an embodiment of the present invention, there is no memory, and thus the simple CPU 102 performs the main control function. Therefore, current consumption can be reduced, and operation can be stabilized even when a capacity of the battery 104 embedded in the smart card is small. Also, when the smart card 100 is an OTP card, the display device 103 and the CPU 102 for controlling operation of the display device 103 are necessarily provided, and thus it is possible to implement the circuit of FIG. 4 using the CPU 102.

Meanwhile, since operation of the MCU 101 and the fingerprint detection device 130 is prevented while the function of the smart card is performed, current consumption can be further reduced.

Actually, a conventional smart card shows a current consumption of about 40 mA to about 80 mA, whereas an operating method of a smart card according to an embodiment of the present invention shows a current consumption of about 5 mA to about 20 mA.

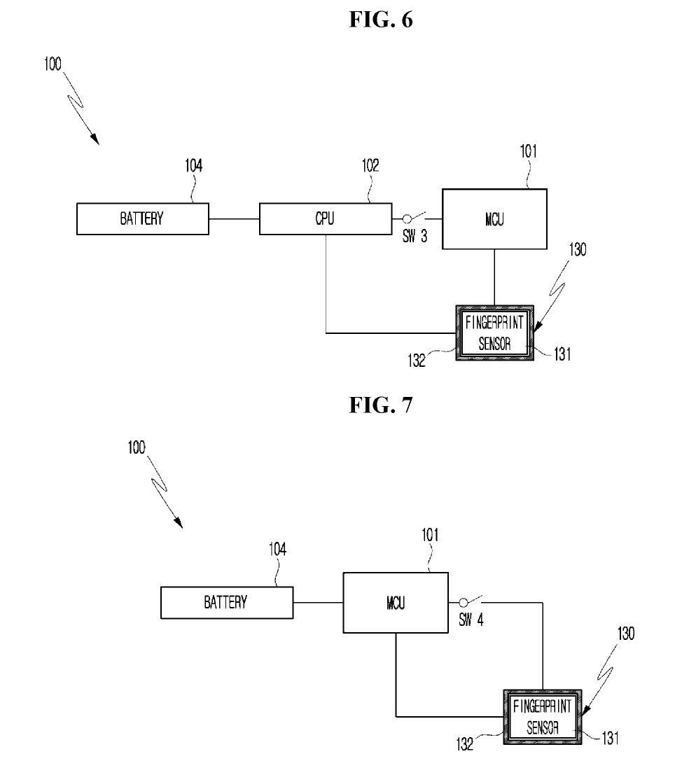

FIG. 6 is a circuit diagram showing an internal configuration of a smart card according to another embodiment of the present invention.

Referring to FIG. 6, a smart card 100 may include an MCU 101, a CPU 102, a battery 104, and a fingerprint detection device 130. In the embodiment shown in FIG. 6, physical switches for controlling connection between the CPU and an auxiliary chip, a display device, and the battery may be provided, like in FIG. 4, but are not shown in the drawing to simplify the drawing.

In the smart card 100 according to the other embodiment of the present invention, the fingerprint detection device 130 is implemented as a fingerprint sensor 131 and an external electrode 132 which is a predetermined distance away from the fingerprint sensor 131 while surrounding the fingerprint sensor 131. When the fingerprint detection device 130 is implemented as a capacitive fingerprint sensor, the external electrode 132 serves as a driving electrode. In other words, a driving signal is applied to the external electrode 132 which functions as a driving electrode, and response signals are input from a finger to the fingerprint sensor 131 in response to the application of the driving signal. The MCU 101 acquires a fingerprint image by aggregating the response signals from the fingerprint sensor 131 and performs a fingerprint authentication process.

The external electrode 132 is made of a metallic material and connected to the CPU 102 in a pin-to-pin manner.

Meanwhile, the CPU 102 and the MCU 101 are connected or disconnected by a third switch SW3, and the MCU 101 is connected to the fingerprint sensor 131 of the fingerprint detection device 130.

The smart card 100 according to the embodiment shown in FIG. 6 is operated through the following process.

First, as power is supplied from the battery 104, the CPU 102 is operated, and the fingerprint detection device 130 is operated by receiving the power of the battery 104 through the CPU 102.

The CPU 102 may be operated in the sleep mode or the active mode by receiving a supply of the power. Although it is advantageous for the CPU 102 to be operated in the sleep mode to minimize current consumption, the CPU 102 may be operated in the active mode because a current consumption thereof is about hundreds of amperes. Meanwhile, the fingerprint detection device 130 may be operated in the sleep mode.

As described above, since the CPU 102 is connected to the external electrode 132 of the fingerprint detection device 130, it is possible to receive an electrical signal from the external electrode 132 periodically or aperiodically.

When a finger comes into contact with the external electrode 132 of the fingerprint detection device 130, an electrical feature (e.g., a resistance value, a permittivity, or the like) of the external electrode varies, and thus the external electrode 132 transmits an electrical signal different from a case in which no finger is present on the external electrode 132.

The CPU 102 compares the signal transmitted from the external electrode 132 with a reference value (a range of a signal received from the external electrode 132 when no finger is present on the fingerprint detection device 130). When the signal exceeds the reference value, the CPU 102 activates the MCU 101 by switching the third switch SW3 to the on-state.

When the electrical feature of the external electrode 132 varies, the fingerprint sensor 131 of the fingerprint detection device 130 may be switched from the sleep mode to the active mode and perform an operation of outputting a fingerprint sensing signal. A signal output from the fingerprint sensor 131 is transmitted to the MCU 101, and the MCU 101 performs a fingerprint image acquisition and fingerprint authentication process based on the received signal. When fingerprint authentication is completed, the auxiliary chip of the smart card communicates with an external device as described above with reference to FIGS. 4 and 5.

According to the present embodiment, only the CPU 101, which consumes a small current, is operated such that current consumption may be minimized before the fingerprint detection device 130 performs the fingerprint sensing process.

Also, according to the present embodiment, since operation of the MCU 101 is determined according to the electrical feature of the external electrode 132 of the fingerprint detection device 130, it is possible to omit a physical switch which should be manipulated by a user to operate the MCU 101.

Since the physical switch is omitted, a production cost of the smart card 100 can be reduced and current consumption can be further reduced. Also, omission of the physical switch leads to a reduction in a physical impact caused by turning on or off the switch, and accordingly, an impact on a printed circuit board (PCB) in the smart card 100 can be minimized.

FIG. 7 is a circuit diagram showing an internal configuration of a smart card according to still another embodiment of the present invention.

Referring to FIG. 7, the still other embodiment of the present invention is a modified example of the embodiment shown in FIG. 6, and it is possible to see that a CPU is omitted in a smart card 100. An MCU 101 is directly connected to an external electrode 132 of a fingerprint detection device 130 and selectively connected to a fingerprint sensor 131 through a fourth switch SW4.

An operating process of the smart card according to the embodiment shown in FIG. 7 will be described below.

When power is supplied to the MCU 101 from a battery 104, the MCU is operated in the sleep mode, and the fingerprint detection device 130 supplied with the power of the battery 104 through the MCU 101 is also operated. It is preferable for the fingerprint detection device 130 to be operated in the sleep mode.

The MCU 101 compares an electrical signal received from the external electrode 132 of the fingerprint detection device 130 with a reference value. When the electrical signal exceeds the reference value, a finger is present on the fingerprint detection device 130, and thus the MCU 101 is switched from the sleep mode to the active mode.

At the same time as or immediately after the switching, the MCU 101 switches the fourth switch SW4 to the on-state, receives an output signal resulting from fingerprint sensing from the fingerprint sensor 131 of the fingerprint detection device 130, and performs a fingerprint image acquisition and fingerprint authentication process,

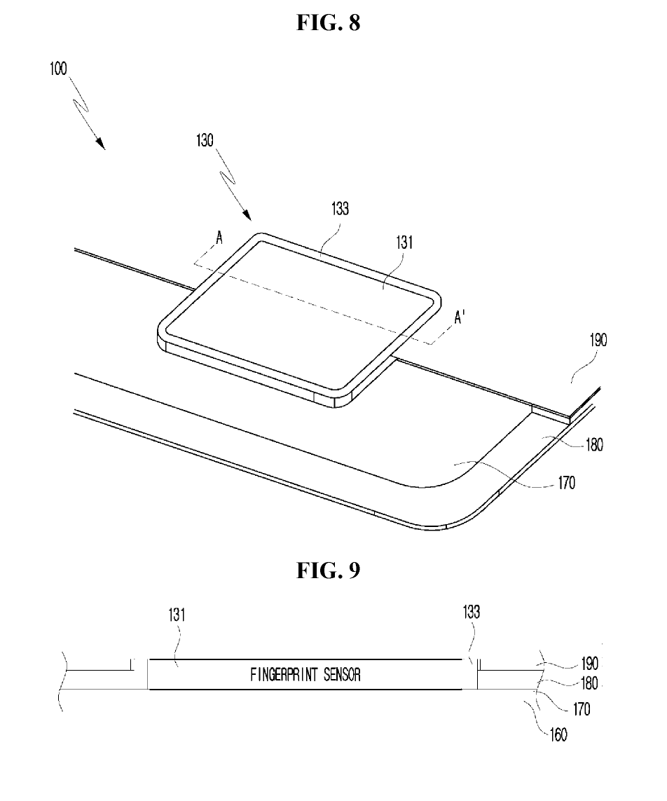

FIG. 8 is an exploded perspective view showing a region in which a fingerprint detection device is formed on a front side of a smart card according to an embodiment of the present invention, and FIG. 9 is a cross-sectional view taken along line A-A′ of FIG. 8.

Referring to FIGS. 8 and 9, a smart card 100 according to an embodiment includes a lower plate 160, a flexible PCB (FPCB) 170 formed on the lower plate 160, and a spacer 180 formed along edges of the smart card 100 on the FPCB 170. A fingerprint detection device 130 according to an embodiment may be installed in a partial region on the FPCB 170, and an upper plate 190 is formed on the spacer 180 to cover the entire smart card 100 excluding the fingerprint detection device 130.

The fingerprint detection device 130 according to an embodiment may include a fingerprint sensor 131 and a support unit 133 formed in a ring shape to surround the fingerprint sensor 131.

The support unit 133 may be made of a metallic material, but is not limited thereto. A lower surface of the support unit 133 comes into contact with the FPCB 170 like the fingerprint sensor 131, and according to an embodiment, an upper surface of the support unit 133 is formed to have the same height as the fingerprint sensor 131.

Since the support unit 133 is made of the metallic material, the support unit 133 primarily protects the fingerprint detection device 130 when a physical impact (e.g., bending, distortion, or the like) is applied to the fingerprint detection device 130. In a conventional smart card to which a fingerprint sensor is applied, a metal plate is additionally attached under the fingerprint sensor to protect the fingerprint sensor. On the other hand, according to an embodiment of the present invention, since the fingerprint detection device 130 is protected from a physical impact by the support unit 133 of the metallic material, it is unnecessary to additionally attach a metal plate under the fingerprint sensor. Accordingly, it is possible to implement a smart card which is safe from a physical impact without the increase in thickness caused by adding a metal plate.

Also, when an additional pad (not shown) is provided on a part of the FPCB 170 which comes into contact with the support unit 133 of the metallic material, an improvement in fingerprint recognition rate of the fingerprint sensor 131 may be expected, and the support unit 133 may also serve as a ground ring which protects the fingerprint sensor 131 from external static electricity.

Meanwhile, since the support unit 133 is made of the metallic material, the support unit 133 may also serve as an external electrode 132 (see FIGS. 6 and 7) which supplies a driving signal when the fingerprint detection device 130 is implemented as the capacitive fingerprint sensor described with reference to FIGS. 6 and 7.

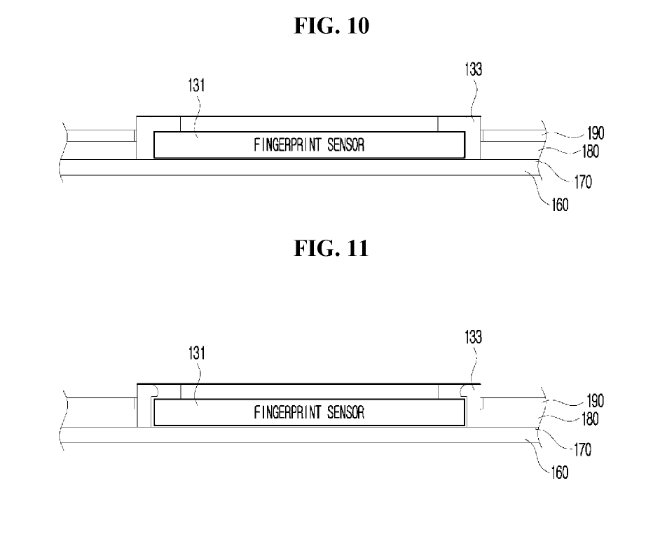

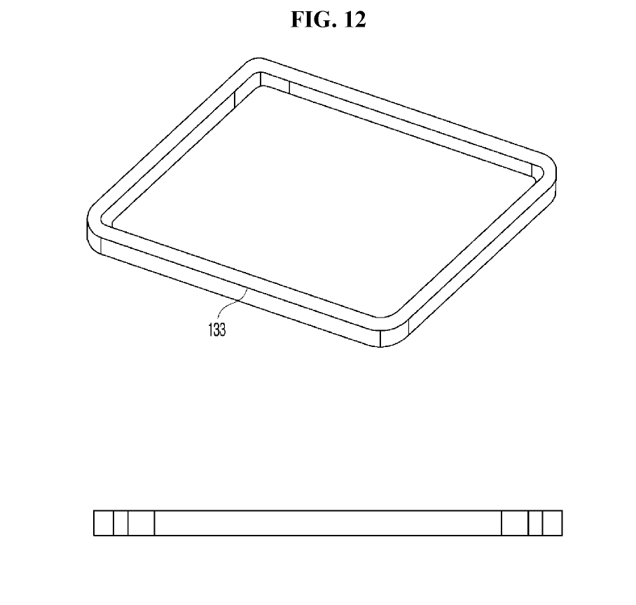

FIGS. 10 and 11 are diagrams showing configurations of a fingerprint detection device of a smart card according to other embodiments of the present invention.

Referring to FIG. 10, in a fingerprint detection device 130, an upper surface of a support unit 133 surrounding a fingerprint sensor 131 may be formed to be higher than an upper surface of the fingerprint sensor 131. Since the support unit 133 is formed to be higher than the fingerprint sensor 131, the upper surface of the fingerprint sensor 131 may be better protected.

Also, as shown in FIG. 11, an upper surface of a support unit 133 may be formed to be higher than an upper surface of a fingerprint sensor 131 and bent inward toward the fingerprint sensor 131 to cover edges of the upper surface of the fingerprint sensor 131. According to the embodiment shown in FIG. 11, an improvement in protection of the fingerprint sensor 131 and a waterproof effect of the fingerprint sensor 131 may be expected.

FIGS. 12 to 14 are diagrams showing shapes of a support unit according to various embodiments of the present invention.

Referring to FIG. 12, a support unit 133 according to an embodiment may be formed to have a structure having flat upper and lower surfaces.

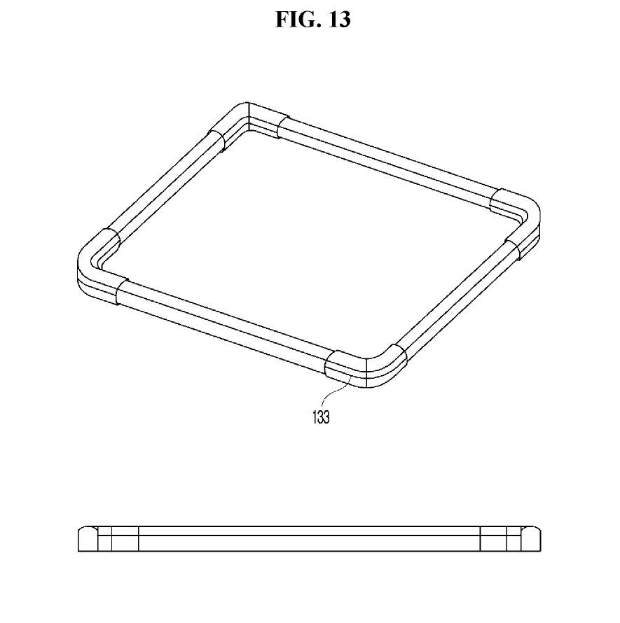

According to another embodiment shown in FIG. 13, a support unit 133 may be formed to have an upper surface having rounded edges.

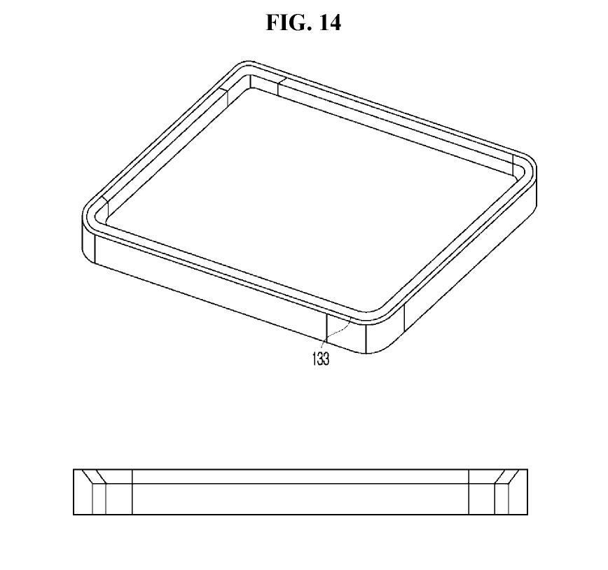

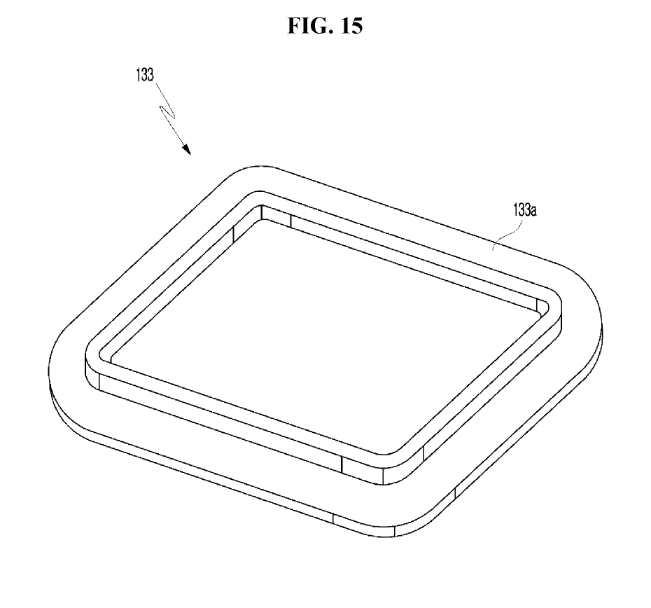

According to still another embodiment shown in FIG. 14, an inclined surface may be formed in an upper portion of a support unit 133 so that an inner diameter thereof gradually increases near an upper surface thereof.

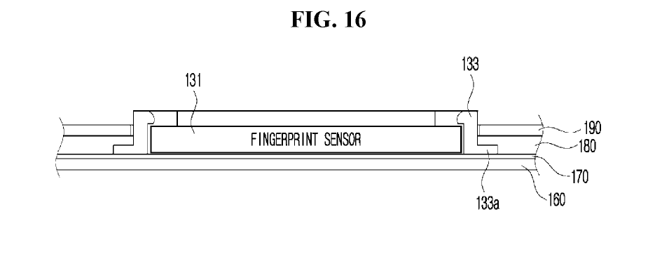

FIG. 15 is a perspective view showing a shape of a support unit according to yet another embodiment of the present invention, and FIG. 16 is a cross-sectional view showing a configuration of a fingerprint detection device of a smart card to which the support unit shown in FIG. 15 is applied.

Referring to FIGS. 15 and 16, a flange 133a may be formed around a lower portion of a support unit 133 surrounding a fingerprint sensor 131. In other words, a lower surface of the support unit 133 may be formed in a shape of the flange 133a. Since the flange 133a is formed, bonding strength and coupling strength between the support unit 133 and components near the support unit 133, that is, a PCB 170, a spacer 180, and the like, may be improved. Also, when a gap and the like between the support unit 133 and the fingerprint sensor 131 is filled with a resin such as epoxy and the like, a waterproof effect may be improved.

Although FIG. 16 shows an embodiment in which an upper surface of the support unit 133 is bent inward to cover edges of the fingerprint sensor 131, the upper surface may be formed not to cover edges of the fingerprint sensor 131, as shown in FIGS. 9 and 10.

The above description of the present invention is provided for illustrative purposes, and those of ordinary skill in the technical field to which the present invention pertains should understand that the present invention can be easily modified into other specific forms without changing the technical spirit or essential features of the present invention. Therefore, it should be understood that the above-described embodiments are illustrative only in all aspects and are not restrictive. For example, each component which is described as a single part can be implemented in a distributed manner. Likewise, components which are described as distributed parts can be implemented in a combined manner.

The scope of the present invention is presented by the following claims. It should be understood that all changes or modifications derived from the definitions and scope of the claims and their equivalents fall within the scope of the present invention.

1. A smart card including a fingerprint detection device, the smart card comprising:
a central processing unit (CPU);
a microcontroller unit (MCU) selectively connected to the CPU and configured to perform fingerprint authentication based on a fingerprint sensing signal received from the fingerprint detection device; and
an auxiliary chip connected to the CPU and configured to be activated when a result of the fingerprint authentication is a success.

2. The smart card of claim 1, wherein the MCU is operated in a sleep mode when connected to the CPU and is switched to an active mode and performs the fingerprint authentication when a magnitude of an electrical signal received from the fingerprint detection device exceeds a reference value.

3. The smart card of claim 1, wherein, when the auxiliary chip is activated, the MCU is disconnected from the CPU.

4. The smart card of claim 1, further comprising:
a first switch configured to connect the CPU to the MCU and the fingerprint detection device when power is supplied to the CPU; and
a second switch configured to connect the auxiliary chip and the CPU when the result of the fingerprint authentication is success.

5. The smart card of claim 4, further comprising:
a physical switch configured to supply the power to the CPU.

6. The smart card of claim 1, further comprising:
a display device configured to be controlled by the CPU and display the fingerprint authentication result information and operation result information of the auxiliary chip and the CPU.

7. The smart card of claim 1, wherein the fingerprint detection device comprises a fingerprint sensor and an external electrode formed to surround the fingerprint sensor, and
when an electrical signal received from the external electrode of the fingerprint detection device exceeds a reference value, the CPU activates the MCU and the fingerprint authentication operation is performed.

8. The smart card of claim 7, further comprising:
a switch configured to connect the CPU and the MCU when the electrical signal exceeds the reference value.

9. The smart card of claim 1, wherein the fingerprint detection device comprises:
a fingerprint sensor; and
a support unit made of a metallic material and formed in a ring shape surrounding the fingerprint sensor.

10. The smart card of claim 9, wherein an upper surface of the support unit has a height equal to or greater than a height of an upper surface of the fingerprint sensor.

11. The smart card of claim 9, wherein an upper surface of the support unit is formed to be higher than an upper surface of the fingerprint sensor and bent inward toward the fingerprint sensor to cover edges of the upper surface of the fingerprint sensor.

12. The smart card of claim 9, wherein the support unit has a structure having flat upper and lower surfaces, a structure whose upper surface has rounded edges, or a structure whose upper portion has an inner diameter gradually increased near the upper surface thereof.

13. The smart card of claim 9, wherein a flange is formed around a lower portion of the support unit.

14. A smart card comprising:
a fingerprint detection device comprising a fingerprint sensor and an external electrode surrounding the fingerprint sensor; and
a microcontroller unit (MCU) configured to be operated in a sleep mode when power is applied thereto and switched to an active mode in which a fingerprint authentication process is performed when an electrical signal received from the external electrode exceeds a reference value.

15. The smart card of claim 14, further comprising:
a switch configured to connect the fingerprint sensor and the MCU when the electrical signal received from the external electrode exceeds the reference value.

16. An operating method of a smart card comprising a fingerprint detection device, the method comprising:
receiving, by a central processing unit (CPU), power and operating a microcontroller unit (MCU) in a sleep mode;
receiving, by the MCU, an electrical signal from the fingerprint detection device and comparing the electrical signal with a reference value;
when the electrical signal exceeds the reference value, switching the MCU to an active mode, and performing, by the MCU, a fingerprint authentication process; and
when a result of the fingerprint authentication is successful, activating, by the CPU, an auxiliary chip.

17. The operating method of claim 16, further comprising:
disconnecting, by the CPU, the MCU from the CPU when the result of fingerprint authentication is success.

18. An operating method of a smart card including a fingerprint detection device, the method comprising:
receiving, by a central processing unit (CPU), an electrical signal from an external electrode of the fingerprint detection device and comparing the electrical signal with a reference value; and
when the electrical signal exceeds the reference value, activating, by the CPU, a microcontroller unit (MCU) so that a fingerprint authentication process is performed.

19. An operating method of a smart card including a fingerprint detection device, the method comprising:
operating a microcontroller unit (MCU) in a sleep mode, and receiving, by the MCU, an electrical signal from an external electrode of the fingerprint detection device; and
when the electrical signal exceeds the reference value, connecting the MCU to a fingerprint sensor of the fingerprint detection device, and performing, by the MCU, a fingerprint authentication process.
